(19) United States
(12) Patent Application Publication
(10) Pub. No.: US 2009/0274512 A1
(43) Pub. Date: Nov. 5, 2009

(54) CONNECTOR PROFILE UNIT FOR PANELS

(76) Inventor: Aharon TAVIVIAN, Omer (IL)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 12/429,547

(22) Filed: Apr. 24, 2009

(30) Foreign Application Priority Data
May 5, 2008 (IL) 191243

(51) Int. Cl. F16B 2/22

(52) U.S. Cl. 403/354

(57) ABSTRACT

A connector profile unit for connecting a panel to another panel or to any other element, wherein the profile unit includes a first end segment, a second end segment and a middle segment in between attached to both end segments, and wherein each of the two end segments has a mouth in the shape of an open channel, each mouth having a pair of lips, the inner faces of the lips are smooth along the channel. The lips are made of a flexible plastic material and at least the two end segments are made of at least a semi-rigid plastic material, all three segments and the lips being co-extruded as a single, integral unit. Of the two end segment channels one is sized for receiving a first enclosure panel and the other is sized for receiving a second enclosure or any other element.

This present invention relates to a connector profile unit for panels. More particularly, it relates to plastic connector profiles, used for panels which together constitute shower stalls, display booths in exhibitions, office furniture and the like.

The panels we deal with may be sheets of glass, plastic, wood, pressboards, metal, non-metal, or of any other material.

The plastic profile unit in accordance with our invention is used to connect between panels, or between a panel and any other element, e.g. a wall. The said profile may also connect between panels serving as a hinge.

Profiles of plastic for the above mentioned aims are already known in the prior-art and the applicant of this patent himself described such, in other of his inventions e.g. Israel patents No. 120465 and No. 131824.

One crucial disadvantage in all existing plastic connector profiles for panels, is the way they hold the panel. Experience proves that the existing plastic profiles are not able to hold tightly the panel by themselves. All attempts to shape the internal walls of the channel of the profile with recesses, or flexible projections, to hold the panel independently without using an adhesive and/or a sealant, failed to do so. Thus all existing plastic profiles whether bearing internal smooth walls, or non-smooth walls, are up today attached to a panel by external means as adhesive, or sealants, or welding or soldering. The said external attachment means are expensive, difficult to handle and much skill is needed to achieve results without defects.

Another disadvantage of the existing plastic connection profiles is that the market prefers connector profiles of transparent plastic, but using those with an adhesive or sealant, causes an ugly appearance.

It is the object of the present invention to obviate the above mentioned disadvantages of the prior art and to provide a plastic profile that will firmly grasp a panel independently without using any external means and the grasping being performed without the need of a professional person with special skills and knowledge.

The present invention achieves the above objectives by providing a connector profile unit for connecting panels, said profile unit comprising a first end segment, a second end segment and a middle segment in between attached to both end segments. Each of the two end segments has a mouth in shape of a channel, the mouth having a pair of lips, the channel sized for receiving an insertion panel or the like and the lips for grasping tight and holding said panel or inserted element, the end segments being made of rigid or semi-rigid plastic material said lips being made of flexible material; while the whole profile being extruded as a single, integral unit.

Moreover, to achieve the aims of our present invention, the end segments of the connector profile unit are extruded of a rigid, or semi-rigid plastic material and inwards the mouth of each end segment, are extruded smooth flexible lips. Each of the flexible lips at its edge is shaped as a domed end. The total described connector profile unit of our invention; is co-extruded as a single integral linear unit.

Our above described connector unit may be for instance of PVC (polyvinyl chloride), the two end segments being of properties such as: special gravity 1.27, tensile strength 2950, hardness shore A 90, while the properties of the flexible lips and their domed edges are such as: special gravity 1.22, tensile strength 2750 and hardness shore A 85.

Such a connector profile unit will grasp firmly the two panels which are inserted in it, omitting the necessity of any external help as adhesive, sealant or the like. Not using external help, our transparent connector profiles have an esthetical and friendly appearance.

Our solution presents a very strong attachment, yet much less expensive than those solutions suggested by the prior art and no expensive skilled workers are needed for assembling the panels to our profile.

### IN THE DRAWINGS

FIG. 1 demonstrates two embodiments of a connector profile unit in accordance with the invention, each being able to connect two panels of equal thicknesses.

FIG. 2 is an end view of another embodiment of the connector profile unit in accordance with the invention aimed to connect two panels of different thicknesses.

FIG. 3 shows how the plastic connector profile unit of our invention is grasping and holding a panel which was inserted into the connector profile.

FIG. 4 demonstrates a connection unit fixed to a wall and being grasped by any connector profile of FIGS. 1a, 1b or 2.

### DESCRIPTION

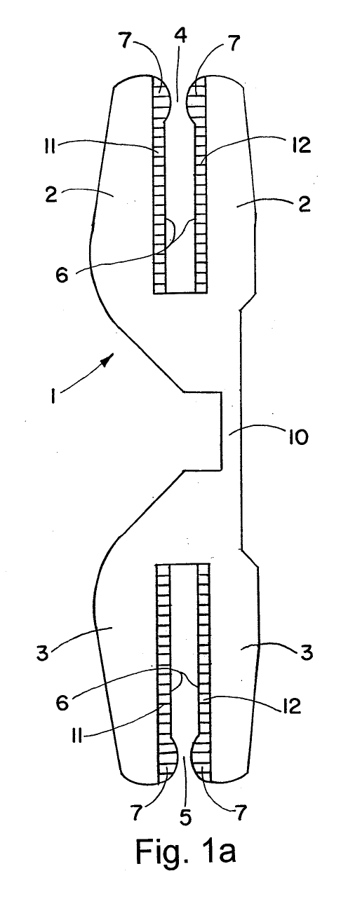

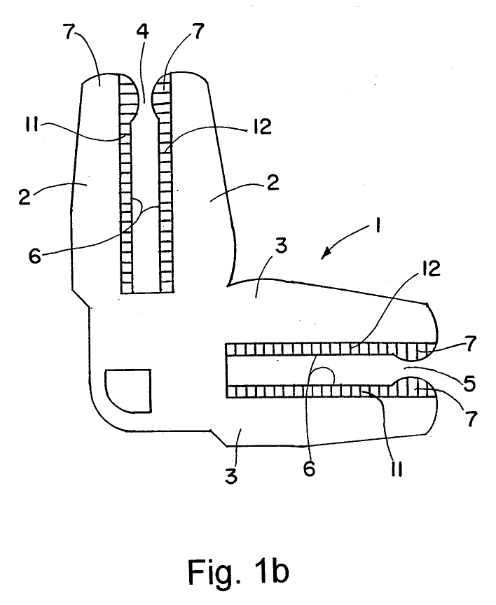

There is seen in FIGS. 1a and 1b a connector profile unit 1 for connecting two enclosure panels (not shown). A first end segment 2 has a mouth shaped as an open channel 4 sized for receiving therein a first enclosure panel (not shown). The other end segment 3 has a mouth shaped as an open channel 5 sized for receiving therein another enclosure panel (not shown). The open channel 4 and the open channel 5 are of same width.

Profile unit 1 as shaped in FIG. 1b is either produced as a rectangular profile unit, or as a flat unit as in FIG. 1a and being then bended.

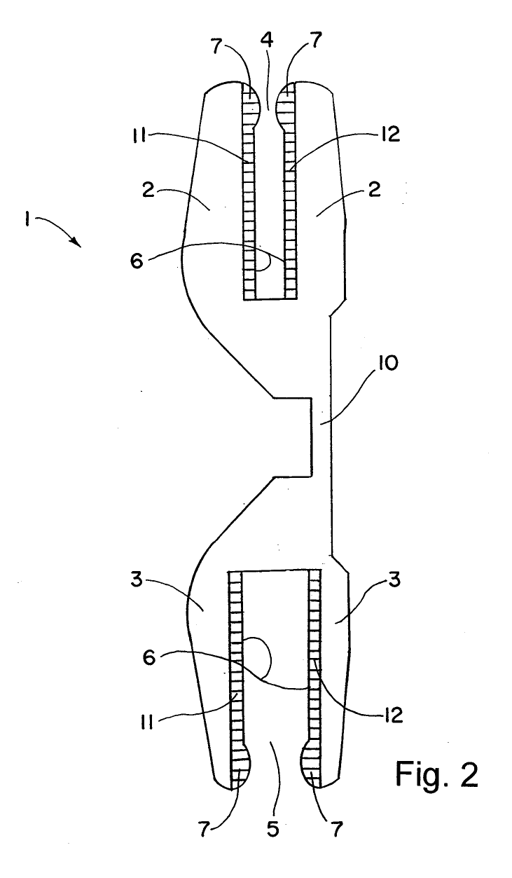

Referring to FIG. 2, in this embodiment the connector profile unit is in general the same as in FIG. 1 however the width of channel 4 is different than that of channel 5. Channel 4 is less in width than channel 5. These enables the connecting of two enclosure panels of different thicknesses.

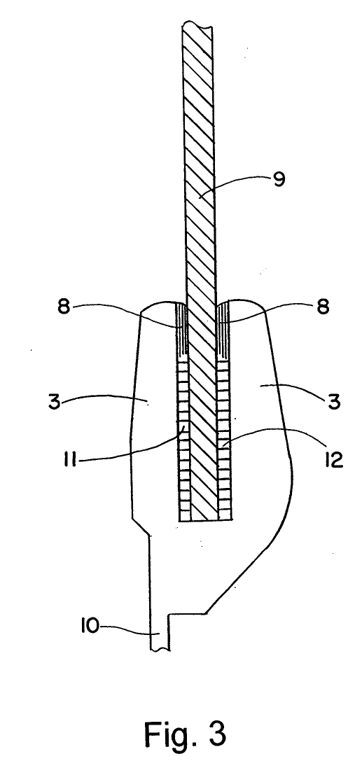

The inner faces 6 of flexible lips 11 and 12 of channels 4 and 5 are smooth all along the channels, except at their open ends. The open ends 7 may be domed. The insertion of a panel into channel 4 or 5 squeezes the domed ends 7 of the channel and changes its shape to a flat compressed plane 8 as seen in the illustration of FIG. 3.

In FIG. 3 is seen a panel 9 inserted in the end segment 3. Flexible lips 11 and 12 together with the domed ends 7, which turned into the heavy compressed area 8 after the insertion of plane 9, are grasping very firmly and stable panel 9.

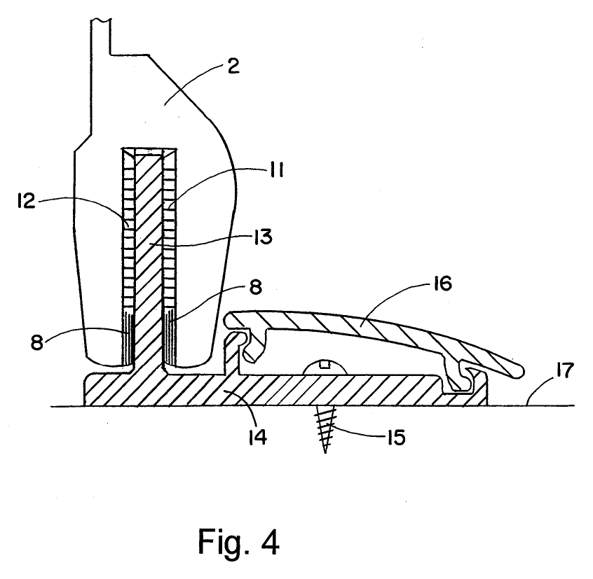

Referring to FIG. 4, a connection unit 14 is mounted to a wall 17 by a screw 15. Cover 16 is hiding screw 15. Connection unit 14 has a protrusion 13 in the thickness of a regular panel (see panel 9 in FIG. 3). A first end segment 2 receives in between its lips 11 and 12 the protrusion 13, thus connector profile unit 1 is fixed to the wall 17 at its end segment 2, while grasping and holding a panel in its second end segment (not shown).

Protrusion 13 may be wholly inserted in between lips 11 and 12 as seen in FIG. 4, or only being inserted partially, thus enabling end segment 2 of connector profile unit 1 to be mounted to wall 17 in a different desired distance from said wall 17.

It will be evident to those skilled in the art that the invention is not limited to the details of the foregoing illustrated embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

1. A connector profile unit for connecting a panel to another panel or to any other element, said profile comprising:
a first end segment, a second end segment and a middle segment in between attached to both end segments,
each of the two end segments has a mouth in the shape of an open channel, each mouth having a pair of lips, the inner faces of the lips are smooth along the channel,
said lips being made of a flexible plastic material while at least the two end segments are made of at least a semi-rigid plastic material, all three segments and the lips being co-extruded as a single, integral unit,
one of the two end segment channels sized for receiving a first enclosure panel and the other end segment channel sized for receiving a second enclosure or any other element.

2. The connector unit according to claim 1, wherein the lips of the open end of the channel are domed.

3. The connector profile unit according to claim 1, wherein the entire profile is made of PVC (polyvinylchloride) material, at least the end segments are made of at least semi-rigid PVC while the lips of each mouth of each end segment are made of flexible PVC.

4. The connector profile unit according to claim 1, wherein the properties of the flexible lips are: special gravity close to 1.22, tensile strength about 2750 and hardness shore round 85.

5. A connector profile unit according to claim 1, wherever used in shower stalls.

6. A connector profile unit according to claim 1, whenever used in office furniture.

7. A connector profile unit according to claim 1, whenever used in display booths in exhibitions.

8. A connector profile unit to claim 1, further comprising a connection unit which is mounted to a wall, in order to connect a panel to a wall by the means of said connector profile.

9. (canceled)

10. The connector profile unit according to claim 2, wherein the properties of the flexible lips are: special gravity close to 1.22, tensile strength about 2750 and hardness shore round 85.
